(19) United States
(12) Patent Application Publication
(10) Pub. No.: US 2014/0125730 A1
(43) Pub. Date: May 8, 2014

(54) Method for Printing Phase Change Ink onto Porous Media

(71) Applicant: XEROX CORPORATION, Norwalk, CT (US)

(72) Inventors: Joanne L. Lee, Rochester, NY (US); Paul J. McConville, Webster, NY (US); Jason O'Neil, Rochester, NY (US); Jule W. Thomas, JR., West Linn, OR (US)

(73) Assignee: XEROX CORPORATION, Norwalk, CT (US)

(21) Appl. No.: 13/670,829

(22) Filed: Nov. 7, 2012

(51) Int. Cl. B41J 2/015

(52) U.S. Cl. 347/20

(57) ABSTRACT

Disclosed is a process which comprises: (a) printing a first fast-solidifying image onto a porous print medium with a fast-solidifying phase change ink; and (b) thereafter printing a second slow-solidifying image onto the print medium with a slow-solidifying phase change ink, said slow-solidifying image being printed onto the fast-solidifying image on the print medium.

### BACKGROUND

Disclosed herein is a process for printing phase change ink onto porous media.

Ink jet printers generally include at least one printhead that ejects drops of liquid ink onto a recording or image forming medium. A phase change ink jet printer employs phase change inks that are substantially solid or gelatinous at ambient temperature, but transition to liquid at an elevated temperature. The molten ink can then be ejected directly onto a recording substrate, such as paper (referred to as direct printing or direct marking), or onto an intermediate imaging member, such a drum or belt, for subsequent transfer to a recording substrate (referred to as indirect printing or marking or offset printing).

In both direct and offset printing architecture, images may be formed on cut sheets or a very long, i.e., continuous, web of medium. Phase change ink web printers may be configured to print images onto a single side of the web, referred to herein as simplex printing, or onto both sides of the web, referred to herein as duplex printing.

One difficulty encountered with both simplex and duplex phase change ink printing arises when printing with inks that are slow to solidify on the print medium. While some inks solidify in times such as one second or less, other phase change inks may take longer as a result of ink rheology, the presence of pigment dispersants, or other similar causes. Especially when printing onto porous media, when an ink is slow to solidify on the medium, the ink in liquid phase has time to seep into the pores of the medium, resulting in showthrough of the image on the opposite side of the medium.

Accordingly, while known compositions and processes are suitable for their intended purposes, a need remains for apparatus and processes that enable phase change ink jet printing with slow solidifying inks onto porous media with reduced showthrough.

### SUMMARY

Disclosed herein is a process which comprises: (a) printing a first fast-solidifying image onto a porous print medium with a fast-solidifying phase change ink; and (b) thereafter printing a second slow-solidifying image onto the print medium with a slow-solidifying phase change ink, said slow-solidifying image being printed onto the fast-solidifying image on the print medium. Also disclosed is a process which comprises: (a) printing a first fast-solidifying image onto a first surface of a porous print medium with a fast-solidifying phase change ink, said fast-solidifying phase change ink solidifying in one second or less upon contact with the print medium; and (b) thereafter printing a second slow-solidifying image onto the print medium with a slow-solidifying phase change ink, said slow-solidifying phase change ink solidifying in more than one second upon contact with the print medium, said slow-solidifying image being printed onto the fast-solidifying image on the print medium; wherein the fast-solidifying image and the slow-solidifying image are printed onto only one surface of the print medium. Further disclosed is a process which comprises: (a) printing a first fast-solidifying image onto a porous print medium with a fast-solidifying phase change ink, said fast-solidifying phase change ink solidifying in one second or less upon contact with the print medium; and (b) thereafter printing a second slow-solidifying image onto the print medium with a slow-solidifying phase change ink, said slow-solidifying phase change ink solidifying in more than one second upon contact with the print medium, said slow-solidifying image being printed onto the fast-solidifying image on the print medium; wherein fast-solidifying images and slow-solidifying images are printed onto two opposite surfaces of the print medium.

### BRIEF DESCRIPTION OF THE DRAWINGS

FIG. 1 is a simplified elevational view of a direct-to-web, continuous-web, phase-change ink printer.

FIG. 2 is a schematic diagram of a serial duplex printing arrangement that utilizes the imaging device of FIG. 1.

FIG. 3 is a schematic diagram of a mobius duplex printing arrangement that utilizes the imaging device of FIG. 1.

### DETAILED DESCRIPTION

To reduce or eliminate the problem of seepage of the slow-solidifying phase change ink (hereinafter referred to as a “slow ink”) into the pores of a porous print medium, the method and apparatus disclosed herein first prints an undercoat of a fast-solidifying phase change ink (hereinafter referred to as a “fast ink”) onto the porous medium. The undercoat covers the pores of the medium, thereby preventing the slow ink from seeping through the medium.

“Slow ink” is defined as an ink that solidifies in from about 1 to about 15 seconds upon contact with the print medium. “Fast ink” is defined as an ink that solidifies in from about 100 to about 500 milliseconds upon contact with the print medium. The print medium can be maintained at an elevated temperature or a reduced temperature, with reduced temperatures sometimes being employed to reduce the solidification time of the ink. The solidification time used in the definition of “slow ink” and “fast ink” is measured at the temperature at which the print medium is maintained in the print process.

The fast ink can, if desired, be substantially colorless, with no added colorant. Alternatively, the fast ink can be of any desired color, such as cyan, magenta, yellow, red, green, blue, black, or the like. In one specific embodiment, the fast ink is yellow.

Examples of fast inks include those disclosed in U.S. Pat. Nos. 7,381,254, 7,442,242, and 7,658,486, the disclosures of each of which are totally incorporated herein by reference. Examples of slow inks include those of similar formulation but containing pigments or magnetic elements, such as MICR inks, and dispersants, believed to be slow inks because of the presence of the dispersants. Further examples of slow inks include those disclosed in U.S. Patent Publication 2012/0274699, the disclosure of which is totally incorporated herein by reference.

The undercoat can be printed in either a halftone pattern or a solid fill coverage pattern. When halftone patterns are used, coverage is in one embodiment at least about 25%, in another embodiment at least about 50%, and in another embodiment at least about 75%. A halftone pattern can conserve costs for printing the fast ink. A solid fill coverage pattern, on the other hand, simplifies the print process.

Any desired or effective phase change printing process can be used. The process described in the Figures is illustrative and the method is not limited to this particular apparatus or configuration.

For a general understanding of the present embodiments, reference is made to the drawings. In the drawings, like reference numerals have been used throughout to designate like elements.

As used herein, the term “imaging device” generally refers to a device for applying images to print media. “Print medium” may be a physical sheet of paper, plastic, or other suitable physical print substrate for images, whether precut or web fed. The imaging device may include a variety of other components, such as finishers, paper feeders, or the like, and may be embodied as a copier, printer, a multifunction machine, or the like. A “print job” or “document” is normally a set of related sheets, usually one or more collated copy sets copied from a set of original print job sheets or electronic document page images, from a particular user, or otherwise related. An image generally may include information in electronic form which is to be rendered on the print medium by the marking engine and may include text, graphics, pictures, or the like. As used herein, the process direction is the direction in which an image receiving surface, e.g., medium sheet or web, or intermediate transfer drum or belt, onto which the image is transferred moves through the imaging device. The cross-process direction, along the same plane as the image receiving surface, is substantially perpendicular to the process direction.

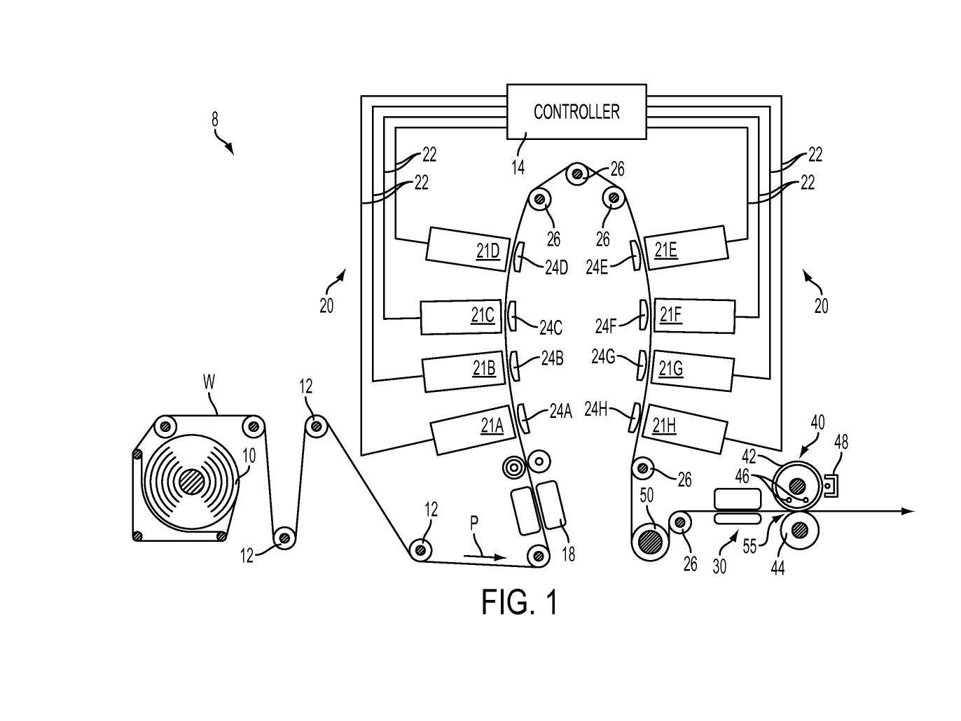

FIG. 1 is a simplified elevational view of an example of a direct-to-sheet, continuous-web, phase-change ink printer 8. A web supply and handling system is configured to supply a very long (i.e., substantially continuous) web W of porous print medium (paper, plastic, or other printable material) from a spool 10. The web W may be unwound as needed, and propelled by a variety of motors (not shown). The web supply and handling system is capable of transporting the web W at a plurality of different speeds. A set of rolls 12 controls the tension of the unwinding web as the web moves through a path.

Along the path there is provided preheater 18 configured to bring the web to a target preheating temperature for printing, which in one practical embodiment, depending on the medium type and ink formulation, is in a range of from about 30° C. to about 70° C. The preheater 18 can rely on contact, radiant, conductive, convective, or the like heat to bring the web W to the target preheat temperature.

After the preheater 18, the web W moves through a print zone 20 including a series of printheads 21A-21H, each printhead effectively extending across the width of the web and being able to place ink directly (i.e., without use of an intermediate or offset member) onto the moving web. Eight printheads are shown in FIG. 1, although more or fewer printheads may be used. In the illustrated embodiment, printheads 21A and 21B are used for undercoating with the fast ink and printheads 21C through 21H are used for printing with the slow ink. As is generally familiar, each of the four primary-color images placed on overlapping areas on the web W combine to form color images, based on the image data sent to each printhead through image path 22 from print controller 14. In various possible embodiments, there may be provided multiple printheads for each primary color; the printheads can each be formed into a single linear array. The function of each color printhead can be divided among multiple distinct printheads located at different locations along the process direction, or the printheads or portions thereof can be mounted movably in a direction transverse to the process direction P, such as for spot-color applications.

Operation and control of the various subsystems, components, and functions of the machine or printer 8 are performed with the aid of the controller 14. The controller 14 may be a self-contained, dedicated mini-computer having a central processor unit (CPU), electronic storage, and a display or user interface (UI) (not shown). The controller 14 receives and manages image data flow between image input sources (not shown), which may be a scanning system or an online or a work station connection, and the printheads. The controller generates control signals that are delivered to the components and subsystems. These control signals, for example, include drive signals for actuating the ink jets of the printheads to eject drops in timed registration with each other and with the movement of the web W to form images thereon.

The marking material applied to the web is a phase change ink, by which is meant that the ink is substantially solid or gelatinous at room temperature and substantially liquid when heated and initially jetted onto the web W. Currently common phase change inks are typically heated to from about 100° C. to about 140° C., and thus in liquid phase, upon being jetted onto the web W.

Each printhead may have a backing member 24A-24H, typically in the form of a bar or roll, which is arranged substantially opposite the printhead on the other side of web W. Each backing member is used to position the web W so that the gap between the printhead and the sheet stays at a known, constant distance. Each backing member can be controlled to cause the adjacent portion of the web to reach a predetermined “ink-receiving” temperature, in one practical embodiment, of from about 40° C. to about 60° C. In various possible embodiments, each backing member can include heating elements, cavities for the flow of liquids therethrough, etc.; alternatively, the “member” can be in the form of a flow of air or other gas against or near a portion of the web W. The combined actions of preheater 18 plus backing members 24 held to a particular target temperature effectively maintains the web W in the printing zone 20 in a predetermined temperature range of from about 40° C. to about 70° C.

As the partially-imaged web moves to receive various inks throughout the printing station 20, the temperature of the web is maintained within a given range. Ink is jetted at a temperature typically significantly higher than the receiving web's temperature, which heats the surrounding paper (or whatever substance the web W is made of). Therefore the members in contact with or near the web in zone 20 are adjusted so that that the desired web temperature is maintained. For example, although the backing members may have an effect on the web temperature, the air temperature and air flow rate behind and in front of the web may also impact the web temperature. Accordingly, air blowers or fans may be utilized to facilitate control of the web temperature.

The web temperature is kept substantially uniform for the jetting of all inks from printheads in the printing zone 20. This uniformity is valuable for maintaining image quality, and particularly valuable for maintaining constant ink lateral spread (i.e., across the width of web W, such as perpendicular to process direction P) and constant ink penetration of the web. Depending on the thermal properties of the particular inks and the web, this web temperature uniformity may be achieved by preheating the web and using uncontrolled backer members, and/or by controlling the different backer members 24A-24H to different temperatures to keep the substrate temperature substantially constant throughout the printing station. Temperature sensors (not shown) associated with the web W may be used with a control system to achieve this purpose, as well as systems for measuring or inferring (from the image data, for example) how much ink from a given printhead is being applied to the web W at a given time. The various backer members can be controlled individually, using input data from the printhead adjacent thereto, as well as from other printheads in the printing station.

In an optional specific embodiment, following the print zone 20, along the path of web W, is a “spreader” 40, that applies a predetermined pressure, and in some implementations, heat, to the web W. The function of optional spreader 40 is to take what are essentially isolated droplets of ink on web W and smear them out to make a continuous layer by pressure, and, in one embodiment, heat, so that spaces between adjacent drops are filled and image solids become uniform. In addition to spreading the ink, the spreader 40 may also improve image permanence by increasing ink layer cohesion and/or increasing the ink-web adhesion. The spreader 40 includes a spreader roll 42, or drum, and a pressure roller 44 that are arranged with respect to each other to define a spreading nip 55 through which the web is fed.

For optimum spreader performance, ink and web temperatures should be substantially uniform prior to entering the spreading nip 55 and be at a target temperature or within a target temperature range that promotes adherence of the melted ink to the web, minimizes showthrough of the ink through the web, and maximizes ink dot spread. The target temperature and the target temperature range for the ink and web temperatures prior to entering the spreading nip 55 may also be referred to as the spreading temperature or spreading temperature range. In addition, the process of bringing the ink and web temperatures to the spreading temperature or spreading temperature range may also be referred to as equalization of the ink and web temperatures. In one embodiment, the spreading temperature may be any temperature from about 30° C. to about 80° C., and, in one particular embodiment, is about 55° C. The spreading temperature or temperature range, however, may be any suitable temperature or range of temperatures depending on a number of factors such as the ink formulation, web substrate material, web velocity, and the like.

To equalize the ink and web temperatures at the target spreading temperature, a temperature leveling roller 50 and/or one or more midheaters 30 are positioned along the media path following the print station 20 to equalize the web and ink temperatures and to bring the web and ink temperatures to a target temperature for spreading prior to being fed through the spreading nip. The leveler roller 50 is a temperature controlled, thermally conductive roller designed to operate at a target temperature to equalize the incoming ink and web temperatures. The leveler roller 50 may be formed of a thermally conductive material, such as aluminum, although the core may be made of other suitable materials, such as iron, nickel, stainless steel, or various synthetic resins. The development of thermal energy in the leveler roller 50 may be accomplished in any suitable manner. For example, the leveling roller may include heating and/or cooling elements (not shown) for maintaining the surface of the leveler roller at the desired operating temperature.

During operation, as the web is moved along the web path, the web W is wrapped partially around the leveler roller 50 as seen in FIG. 1. The length of the web that contacts the leveler roller 50 is referred to herein as the wrap length, or contact length. Contact between the higher ink and web temperature with the lower temperature of the leveler roller 50 causes conductive heat transference to occur between the web and the leveler roller thereby lowering the temperature of the ink and web toward the operating temperature of the leveler roller. The extent to which the ink and web temperatures may be equalized, or leveled, is generally a function of the temperature of the leveler roller 50, and the length of time, or dwell time, that the web W remains in contact with the leveler roller. As used herein, dwell time refers to the maximum amount of time that any given point on the web remains in contact with the leveler roller. Dwell time between the web and the leveler roller is dependent upon the speed that the web is moving and the wrap length, or contact length, between the web and the leveler roller. The wrap length at which the web is in contact with the web may be any suitable wrap length that is capable of creating adequate dwell time to level the ink and web temperatures in light of the web speed and operating temperature of the leveler roller.

One or more midheaters 30 are positioned along the media path downstream from the leveler roller 50, i.e., after the leveler roller in the process direction P of the media, to heat the equalized ink and web temperatures to a target temperature for spreading. Midheaters 30 can use contact, radiant, conductive, convective, or the like heat to bring the media W to a target temperature. The midheaters 30 bring the ink placed on the media to a temperature suitable for desired properties when the ink on the media is sent through the spreading nip. In one embodiment, a useful range for a target temperature for ink entering the spreading nip is from about 35° C. to about 80° C., and in one particular embodiment is about 55° C.

Further information on embodiments including the optional spreader is disclosed in, for example, U.S. Pat. No. 8,220,918, the disclosure of which is totally incorporated herein by reference.

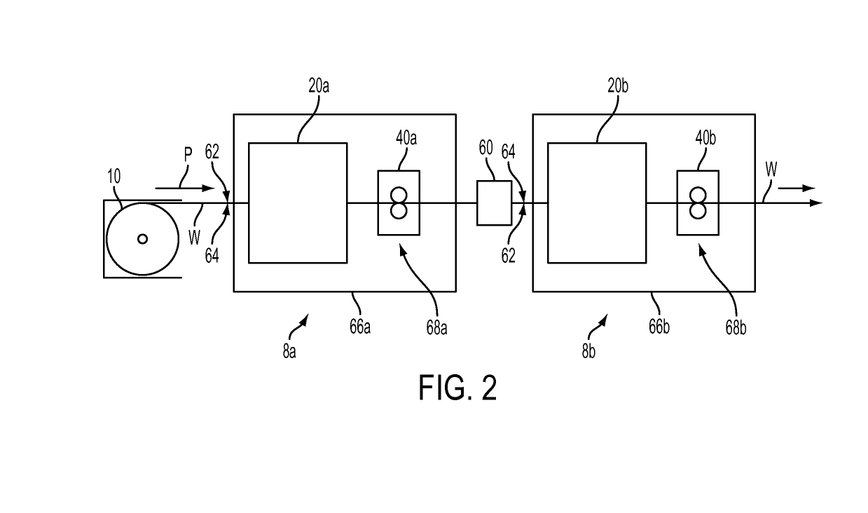

Imaging devices such as the imaging device of FIG. 1 may be used to form images on one side of the web, referred to herein as simplex printing, or both sides of the web, referred to herein as duplex printing. As mentioned, web printers may have a serial web printing arrangement or a mobius web printing arrangement. An example of a serial duplex printing arrangement is depicted in FIG. 2. The exemplary serial arrangement of FIG. 2 includes a first imaging device 8a and a second imaging device 8b arranged in sequence with an inversion system 60 positioned therebetween. During operation, a web W of substrate material is guided from a web source, such as spool 10, through the first imaging device 8a for deposition of ink onto a first side 62, or simplex side of the web, and then guided through the spreading nip of the spreader 40a of the first imaging device 8a, i.e., the first spreader, for spreading the ink and fixing the ink to the simplex side of the web. The inversion system 60 is positioned downstream from the first spreader 40a that is configured to flip or invert the web W so that the second side 64, or duplex side, of the web is facing the appropriate direction for the deposition of ink thereon in the second imaging device 8b. The web, after having been printed on the duplex side, is then guided through the spreading nip of the spreader 40b of the second imaging device 8b, i.e., the second spreader, for spreading the ink on the duplex side 64 and fixing it to duplex side of the web.

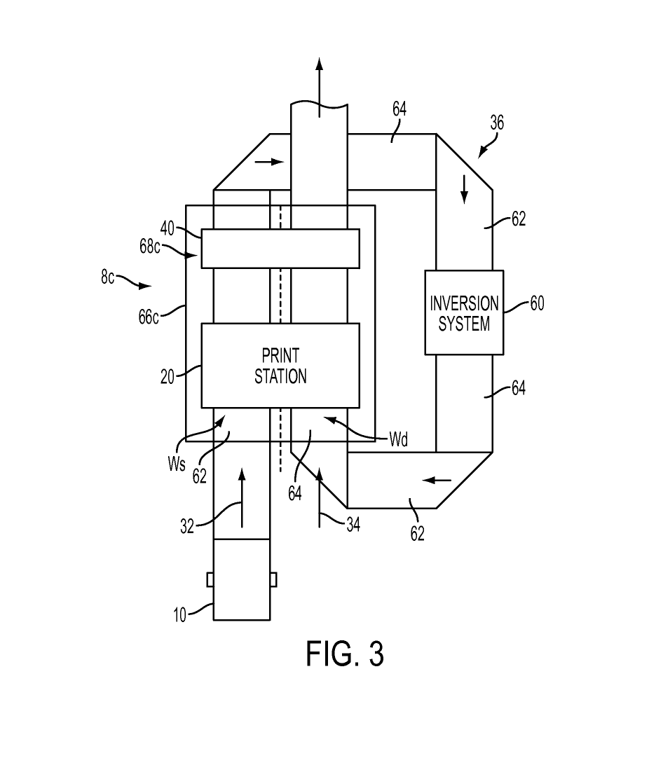

FIG. 3 shows a mobius duplex web printing arrangement that may be implemented using an imaging device 8c which is similar to the imaging device 8 of FIG. 1. As depicted in FIG. 3, the mobius arrangement includes a dual width, or dual path, transport system that is configured to transport two lengths or strands of the web, W_{S} and W_{d}, along parallel web paths 32 and 34 through the print station 20 and a spreader module 40 simultaneously. The web of media in this embodiment may be narrower in the cross-process direction than the web used in the serial arrangement so that the dual paths 32, 34 may be accommodated in a standard width architecture. Alternatively, the transport system and systems, such as the print station 20 and spreader 40, of the imaging device 8c may be widened to accommodate two standard width strands of media.

As depicted in FIG. 3, a first path 32 of the web transport system is configured to transport a portion of the web W_{S} with one of the surfaces, i.e., simplex surface, 62 of the web facing in a direction to be printed upon by the printheads of the print station 20. The second path 34 of the web transport system is configured to transport a portion of the web W_{d} with the opposite surface, i.e., the duplex surface 64, of the web facing the print station. The web transport system is configured to transport the strands through the print station 20. The print station 20 includes print units (not shown in FIG. 3) that are configured to deposit ink onto both lengths of the web W_{S} and W_{d} to form images on both the simplex and duplex side of the web. After traveling through the print station 20, the web lengths W_{S} and W_{d} are guided through the spreader module 40 which is configured to spread the ink deposited onto the web lengths W_{S} and web length W_{d} simultaneously. After being fed through the spreader 40, the first path 32 directs the web W_{S} to a return path 36 along which is positioned an inversion system 60 that inverts the web. The inverted web is then guided along the return path to the entrance of the second path 34 so that the duplex side 64 is facing the print station 20.

In one specific embodiment, showthrough, as measured in optical density units on the surface of the printed medium opposite to that on which the ink image is printed, is 0.05 or less for black inks.

Specific embodiments will now be described in detail. These examples are intended to be illustrative, and the claims are not limited to the materials, conditions, or process parameters set forth in these embodiments. All parts and percentages are by weight unless otherwise indicated.

### Example I

A series of images were generated on a test fixture with functionalities similar to that illustrated in FIG. 1 and having two undercoat stations. XEROX® CIPRESS® yellow ink was first printed onto XEROX 4200 business paper. Images were generated in both halftone and solid patterns. After the yellow ink had dried, a cyan ink prepared as described in Example 1 of U.S. Patent Publication 2012/0274699 containing 90% by weight of amorphous material #5 from Table 2 and 10% by weight of crystalline material #1 from Table 1 was printed on top of the yellow ink images. Thereafter, the optical density on the back side of the paper was measured and was 0.05 or less in all instances.

### Example II

The process of Example I was repeated except that instead of the yellow ink, a similar XEROX® CIPRESS® ink was used having no colorant in it. Similar results were observed.

Other embodiments and modifications of the present invention may occur to those of ordinary skill in the art subsequent to a review of the information presented herein; these embodiments and modifications, as well as equivalents thereof, are also included within the scope of this invention.

The recited order of processing elements or sequences, or the use of numbers, letters, or other designations therefor, is not intended to limit a claimed process to any order except as specified in the claim itself.

What is claimed is:

1. A process which comprises:
(a) printing a first fast-solidifying image onto a porous print medium with a fast-solidifying phase change ink; and
(b) thereafter printing a second slow-solidifying image onto the print medium with a slow-solidifying phase change ink, said slow-solidifying image being printed onto the fast-solidifying image on the print medium.

2. A process according to claim 1 wherein the fast-solidifying phase change ink solidifies in from about 100 to about 500 milliseconds upon contact with the print medium and wherein the slow-solidifying phase change ink solidifies in from about 1 to about 15 seconds upon contact with the print medium.

3. A process according to claim 1 wherein the first fast-solidifying image is printed in a halftone pattern.

4. A process according to claim 3 wherein the halftone pattern has at least about 25% coverage.

5. A process according to claim 1 wherein the first fast-solidifying image is printed in a solid fill coverage pattern.

6. A process according to claim 1 wherein the first fast-solidifying image is substantially colorless.

7. A process according to claim 1 wherein the first fast-solidifying image is colored.

8. A process according to claim 7 wherein the color is yellow.

9. A process according to claim 1 wherein the second slow-solidifying image is printed while the print medium is maintained at a temperature of from about 40° C. to about 70° C.

10. A process according to claim 1 wherein the print medium is paper.

11. A process according to claim 1 wherein the fast-solidifying image and the slow-solidifying image are printed onto only one surface of the print medium.

12. A process according to claim 1 wherein fast-solidifying images and slow-solidifying images are printed onto two opposite surfaces of the print medium.

13. A process according to claim 1 further comprising:
(c) spreading the fast-solidifying images and the slow-solidifying images deposited onto the print medium.

14. A process according to claim 13 wherein the fast-solidifying images and the slow-solidifying images are spread by feeding the print medium through a nip defined by a first roller for contacting the ink deposited onto the print medium and a second roller arranged adjacent to the first roller to define a pressurized nip through which the print medium is fed.

15. A process which comprises:
(a) printing a first fast-solidifying image onto a first surface of a porous print medium with a fast-solidifying phase change ink, said fast-solidifying phase change ink solidifying in one second or less upon contact with the print medium; and
(b) thereafter printing a second slow-solidifying image onto the print medium with a slow-solidifying phase change ink, said slow-solidifying phase change ink solidifying in more than one second upon contact with the print medium, said slow-solidifying image being printed onto the fast-solidifying image on the print medium;
wherein the fast-solidifying image and the slow-solidifying image are printed onto only one surface of the print medium.

16. A process according to claim 15 wherein the first fast-solidifying image is printed in a halftone pattern.

17. A process according to claim 15 wherein the first fast-solidifying image is printed in a solid fill coverage pattern.

18. A process which comprises:
(a) printing a first fast-solidifying image onto a porous print medium with a fast-solidifying phase change ink, said fast-solidifying phase change ink solidifying in one second or less upon contact with the print medium; and
(b) thereafter printing a second slow-solidifying image onto the print medium with a slow-solidifying phase change ink, said slow-solidifying phase change ink solidifying in more than one second upon contact with the print medium, said slow-solidifying image being printed onto the fast-solidifying image on the print medium;
wherein fast-solidifying images and slow-solidifying images are printed onto two opposite surfaces of the print medium.

19. A process according to claim 18 wherein the first fast-solidifying image is printed in a halftone pattern.

20. A process according to claim 18 wherein the first fast-solidifying image is printed in a solid fill coverage pattern.
